(19) United States
(12) Patent Application Publication
(10) Pub. No.: US 2011/0072100 A1
(43) Pub. Date: Mar. 24, 2011

(54) Method for Communicating at Least One Targeted Message from a Service Provider to a User of a Portable Terminal

(75) Inventors: Jeremie Leroyer, Paris (FR); Cyril Porteret, Paris (FR)

(73) Assignee: AIRTAG, Vanves (FR)

(21) Appl. No.: 12/992,349

(22) PCT Filed: May 13, 2009
(86) PCT No.: PCT/FR09/00555

§ 371 Date: Nov. 12, 2010

(30) Foreign Application Priority Data
May 14, 2008 (FR) 0802621

(51) Int. Cl. G06F 15/16

(52) U.S. Cl. 709/206

(57) ABSTRACT

A method for communicating at least one targeted message from a service provider to a user of a portable terminal is provided. The terminal integrates a secure element including at least one information storage register and a system for enabling contactless communication of the secure element with a reader of the service provider. The method includes the creation of a user profile and the recording of same in the register of the secure element. The profile comprises personal data relating to the user with an associated confidentiality level. The method further includes, after identification of the user by contactless communication between his/her terminal and the reader, activation of the confidentiality level that the user accords to the service provider and the communication to the provider of the personal data corresponding to the activated confidentiality level. The personal data is processed to generate at least one targeted message which is communicated to the user.

### BACKGROUND

### Field of the Invention

The invention relates to a method of communicating at least one targeted message from a service provider to a user of a portable terminal, as well as a mobile terminal including an application for the implementation of such a method.

### SUMMARY OF THE INVENTION

The method according to the invention makes it possible in particular for the user to subscribe in a simple manner to a relational programme of a service provider, of a brand or of an advertiser, as compensation for the authorisation given to said provider to send targeted advertising, promotional or informative messages. Furthermore, the method allows for the granting of a reward or of an advantage (gifts or loyalty points, for example) as compensation for the authorisation.

In particular, the invention has a major but not exclusive application in the field of services for distribution stores, but it can also apply in the field of transport, bank payment or access control. In this latter case, the method can in particular be used to provide the user access to a public transportation service as compensation for the display of a targeted promotional or advertising information.

The method according to the invention, qualified as “opting-in” in marketing, allows the user to explicitly express his/her choice to receive messages, and for the provider to offer targeted relational programmes according to the personal data which is communicated to the provider by the user.

The invention has for objective to provide such a method making it more secure and more user-friendly for the user to subscribe to relational programmes, in particular by allowing him to benefit from advantages and promotions as compensation for the sharing of information concerning his/her identity, tastes and affinities.

To this effect, and according to a first aspect, the invention proposes a method of communicating at least one targeted message from a service provider to a user of a portable terminal, said terminal integrating a secure element including at least one information storage register and a means enabling contactless communication of the secure element with a reader of the service provider, said method including the creation of a user profile and the recording of same in the register of the secure element, said profile comprising personal data relating to said user with an associated confidentiality level, said method further including, after identification of the user by contactless communication between his/her terminal and the reader, the activation of the confidentiality level that the user accords to the service provider and the communication to said provider of the personal data corresponding to said activated confidentiality level, said personal data being processed to generate at least one targeted message which is communicated to the user.

According to a second aspect, the invention proposes a mobile terminal integrating a secure element comprising at least one register for storing a profile of the user of said terminal, said profile comprising personal data relating to said user with an associated confidentiality level, said terminal further comprising a means enabling contactless communication of the security element with a reader of a service provider, said terminal further integrating an application allowing for the interaction between said terminal and said reader in order to allow for the implementation of the method of communication.

### BRIEF DESCRIPTION OF THE DRAWING

Other particularities and advantages of the invention shall appear in the following description, provided in reference to the annexed FIGURE which shows the implementation of a method of communication according to an embodiment of the invention.

### DETAILED DESCRIPTION OF THE PREFERRED EMBODIMENT(S)

In reference to this FIGURE, a method of communicating at least one targeted message is described, for example of an advertising, promotional or informative nature, from a service provider to a user of a portable terminal. The service provided is in particular of a commercial nature, the provider able to be a store, a transportation company, a bank, etc.

The targeted message can be part of a relational programme between the user and the provider, for example a loyalty programme, a consumer credit service, a couponing programme, an information letter, an advertising campaign. Furthermore, the relational programme under consideration can relate to several service providers.

In particular, the method according to the invention makes it possible, after explicit acceptation from the user (mode referred to as “opting-in”), for a service provider to subscribe the user to a relational programme as compensation for the communication of data relating to this user, said programme able to be adapted according to the data communicated.

Furthermore, it is possible in particular to count the number of messages displayed and proposed to the user, as well as to count the number of messages that have triggered a particular transaction on an identified product or service. The method thus makes it possible to report in a detailed and secure manner the statistics by profile and by confidentiality level with the purpose of invoicing the service provided for this process.

According to the embodiments shown, the terminal is a portable telephone 1 which integrates at least one secure element including at least one information storage register, in particular in a confidential manner.

The secure element can be incorporated into the memory chip of the telephone 1, in the SIM (Subscriber Identity Module) card or in a memory board of the SD (Secure Digital card) type. Alternatively, the terminal can be a personal assistant of the PDA (Personal Digital Assistant) type.

In particular, the secure element comprises several data registers respectively allocated to several application fields (payment, transport, access control), the application allowing for the implementation of the method of communication being stored in a secure sub-register independent of said element.

The application is able to interact with the security element, as well as with the keyboard 1a, the screen 1b and the telephony network 2. In particular, the application comprises means of reading data stored in the security element, means for read/write data storage, means of calculating and means of displaying des recorded data.

Furthermore, in the case where the security element allows, the application can aggregate several relational programmes, in particular several loyalty programmes, in such a way that the user can share his/her data with the various programmes in question.

The mobile terminal further comprises a means enabling contactless communication of the secure element with a reader of the service provider, said communication being encrypted for confidentiality. According to an embodiment, the contactless communication is carried out by implementing an NFC (Near Field Communication) technology such as defined by the standard RFID 13.56.

In this embodiment, the mobile terminal is provided with a radio frequency tag of the RFID (Radio Frequency Identification) type which includes a transponder in the form of an electronic chip and a communications antenna. Indeed, this type of tag makes possible contactless communication between the content of the electronic chip and a suitable reader, said communication making it possible to read the information contained in the chip and/or to write information to said chip.

In particular, the tag includes an identification number concerning the user. As such, when the user approaches his/her terminal to the reader, the latter can be identified via contactless communication between his/her terminal and the reader.

As a reader, a terminal 3 can be used comprising a means enabling contactless reading of radio frequency tags, said terminal able to be installed in a point of sale of the products of the service provider, or more generally on the premises where the service can be rendered by the provider. According to an embodiment, the terminal 3 can be incorporated into the cash register reader of a shop, in such a way as to be able to use the targeted message during the payment.

The terminal 3 can be of any form compatible with the design of the installation location, in particular in the form of a console or of a wall display, and include a zone 3a across from which the user is encouraged to place his/her radio frequency tag in order to carry out the contactless communication.

The method of communication provides for the creation of a user profile and the recording of same in the register of the secure element, said profile comprising personal data relating to said user with an associated confidentiality level.

The personal data is entered by the user by the intermediary of his/her portable terminal, in particular by using the screen 1b and the keyboard 1a of the portable telephone 1. The user can however carry out this creation by the intermediary of a reader or other key-entry device, for example the interactive terminal 3 or a portable computer. Furthermore, the user can access this data at any time in order to modify it delete it.

Concerning the recording of personal data in the register, the latter can be carried out by coding according to the TLV (Type Length Value) or TV (Type Value) protocol.

According to an embodiment, the TLV coding used makes it possible to minimise the memory footprint while simplifying data management. In order to do this, the coding is carried out:

over one byte (8 bits) for the data type;

over one 2nd byte for the data length (maximum 256);

over the other bytes for the data properly speaking.

In order to further reduce the size occupied, it is possible, for certain types of fixed-length data, to omit the length byte. The coding then becomes TV.

According to an embodiment, the method provides the user with at least one confidentiality level for the personal data that he/she enters. Alternatively, the user himself/herself can choose the associated confidentiality level for the data that he/she enters.

By way of example, five confidentiality levels and associated data types are provided hereinbelow:

Level 0: no personal data.

Level 1: basic personal data (last name, first name, sex, etc.).

Level 2: detailed personal data (food preferences, etc.).

Level 3: full personal data (banking data, etc.).

Level 4: biometric personal data (fingerprint etc.).

In particular, the sharing of level 0 data equivocates to a simple “Opting-in” from the user in order to accept becoming a member of a programme anonymously and be listed in a remote database and receive targeted information based on his/her purchase and visit histories at a point of sale or over a commercial network.

After the user is identified, the method provides to activate the confidentiality level that the user accords to the service provider and to communicate to said provider the personal data corresponding to said activated confidentiality level.

As such, the personal data communicated can be processed in order to generate at least one targeted message, said message then being communicated to the user. In particular, the targeted message can correspond to a targeted service for the user, for example access to a transportation service or an advertising message associated to a service. Furthermore, the targeted message can be generated according to contextual data (time, location, etc.) relating to the contactless communication between the terminal and the reader.

The invention thus makes it possible to put into correspondence personal data of the user, messages from the provider and contextual data, in such a way as to adapt the communication between the provider and the user.

In particular, the confidentiality level that the user accords to the service provider can be activated during the first identification of the user on a reader of the provider. In order to do this, during this first identification, the user may have to complete a participation form that includes the authorised confidentiality level. In an example implementation, the first identification can be carried out at the time of the subscription to a loyalty programme, or during the activation of a credit/payment card.

Furthermore, the data communicated can be recorded by the provider in order to be reused at a later time. As such, it is possible to generate targeted messages for each later identification, and this without the requirement of communicating data again.

Moreover, still during this first identification, the application allowing for the implementation of the method of communication can be downloaded in order to be recorded in a register of the secure element. Alternatively, the application can be downloaded prior to the first identification or be pre-recorded in the security element.

In relation to the FIGURE, the implementation of the method is carried out between the telephone mobile 1, the terminal 3, a remote platform comprising a server of the service provider and the network 2 of the telecommunications operator of the telephone.

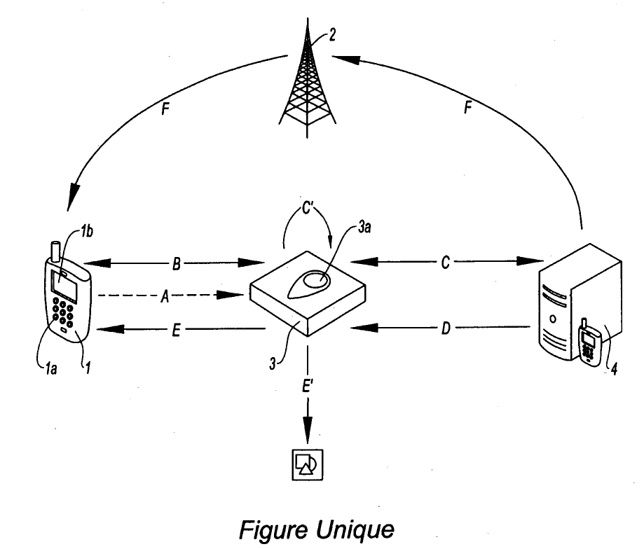

According to FIG. 1, the method provides successively that:

the user be identified via contactless communication between the telephone 1 and the terminal 3 (arrow A);

the telephone 1 transmit the data to the terminal 3 via contactless communication (arrow B);

the terminal 3 transmit to the server 4 the data by the intermediary of a network connection, in particular via internet (arrow C);

the server 4 process this data in order to generate the targeted message;

the server 4 transmit the targeted message to the terminal 3 by the intermediary of said network (arrow D);

the terminal 3 transmit the targeted message without contact to the telephone 1 (arrow E);

the targeted message be displayed on the screen of the telephone 1.

Alternatively to this embodiment:

the personal data is processed by the terminal in order to generate the targeted message (arrow C′); and/or

the targeted message is communicated to the user by display on the reader (arrow E′); and/or

the targeted message is transmitted directly from the server 4 to the telephone 1 by using the network 2 of the operator (arrows F).

According to another alternative, the personal data and/or the targeted message can be communicated to the server 4 by the terminal 1, in particular by using the network of the operator.

A method of communicating a targeted message of the interactive type in order to be communicated by the terminal within the framework of the use of a service of the provider is described hereinbelow. The interactive message can be in particular of the promotional coupon type to be used during a purchase made with the provider.

According to another embodiment, the interactive message can be a data exchange form between the user and the service provider, this type of message able to be generated in the case of the activation of the lowest confidentiality level (Level 0 in the given example, i.e. no personal data transmitted but accepting to receive forms).

The method provides for the recording in the secure element of at least one interactive message in an inactive state. For example, after identification, several promotional coupons can be recorded in an unusable state. In particular, this communication of coupons can be carried out independently to any activated confidentiality level, or with a minimum confidentiality level in order to accept to receive said coupons as compensation in particular for the communication of basic personal data (Level 1 in the given example) in such a way as to personalise the recorded coupons.

Then, a recorded promotional coupon can be activated via an action from the user, in particular via visualisation by the user on the screen 1b of the portable telephone 1. In particular, the user can scroll through the list of recorded coupons and, at each visualisation, a counter is incremented in the secure element in order to change the coupon from an inactive state to an active state.

As such, it is only after it is visualised that a promotional coupon can be used by the user. In particular, during payment for the product concerned by the coupon, said activated coupon can be transmitted to the cash register of the shop via contactless communication between the telephone 1 and a terminal 3 communicating with said cash register.

Alternatively, the method can provide for the recording in the secure element of at least one interactive message in an inactive state, with the processing of the personal data making it possible to generate a targeted interactive message via the activation of a recorded interactive message.

1-18. (canceled)

19. Method of communicating at least one targeted message from a service provider to a user of a portable terminal, said terminal integrating a secure element including at least one information storage register and a means for enabling contactless communication of the secure element with a reader of the service provider, said method including creating a user profile including personal data relating to said user with an associated confidentially level and recording said profile in the at least one storage register of the secure element, after identification of the user by contactless communication between the user's terminal and the reader, activating of the confidentiality level that the user accords to the service provider and the communication to said provider of the personal data corresponding to said activated confidentiality level, and processing said personal data in order to generate at least one targeted message which is communicated to the user.

20. Method of communication according to claim 19, wherein said at least one targeted message generating step comprises generating at least one targeted message of an interactive type in order to be communicated by the terminal within the framework of the utilisation of a service of the provider.

21. Method of communication according to claim 20, further comprising communicating said at least one targeted interactive message to the terminal in order to be recorded in the secure element in an inactive state, and activating a recorded interactive message by an action from the user.

22. Method of communication according to claim 20, further comprising recording in the secure element at least one interactive message in an inactive state, and the step of personal data making it possible to generate a targeted interactive message by activation of a recorded interactive message.

23. Method of communication according to claim 19, further comprising generating the at least one targeted message according to contextual data relating to the contactless communication between the terminal and the reader.

24. Method of communication according to claim 19, further comprising carrying out the contactless communication by implementation of a near field communication (NFC) technology.

25. Method of communication according to claim 19, further comprising entering the personal data by the user by an intermediary of at least one of the user's terminal, the reader and another key-entry device.

26. Method of communication according to claim 25, further comprising offering the user at least one confidentiality level for the personal data that the user enters.

27. Method of communication according to claim 19, wherein said activity step comprises activating the confidentiality level that the user accords to the service provider during first identification of the user on a reader of said provider.

28. Method of communication according to claim 19, further comprising processing the personal data by the reader in order to generate a targeted message.

29. Method of communication according to claim 19, further comprising communicating the personal data to a remote platform, and said platform processing said data and communicating a targeted message to the user.

30. Method of communication according to claim 29, wherein said communicating step comprises communicating the personal data to the remote platform by the reader.

31. Method of communication according to claim 19, further comprising communicating a targeted message to the user via display on the reader.

32. Method of communication according to claim 19, further comprising communicating a targeted message to the user by display on the terminal.

33. Method of communication according to claim 19, wherein communication of the targeted message is carried out by contactless communication between the terminal and the reader.

34. Method of communication according to claim 19, further comprising coding the personal data recorded in the secure element according to TLV or TV protocol.

35. A mobile terminal integrating a secure element comprising at least one register for storing a profile of a user of said terminal, said profile including personal data relating to said user with an associated confidentiality level, said terminal further comprising a means for enabling contactless communication of the secure element with a reader of a service provider, and said terminal further integrating an application allowing for interaction between said terminal and said reader in order to allow for implementation of the method of communication according to claim 19.

36. A mobile terminal according to claim 35, wherein the application is recorded in a register of the secure element.
